(19) United States
(12) Patent Application Publication
(10) Pub. No.: US 2007/0024538 A1
(43) Pub. Date: Feb. 1, 2007

(54) Display Apparatus and Display Control Method

(75) Inventor: Atsushi Yamauchi, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/459,849

(22) Filed: Jul. 25, 2006

(30) Foreign Application Priority Data
Jul. 28, 2005 (JP) P2005-219599

(51) Int. Cl. G09G 3/30

(52) U.S. Cl. 345/76

(57) ABSTRACT

A display apparatus having a display unit that displays images formed by pixels arranged in a plurality of rows and columns is provided. The display apparatus includes: light emitting elements that are respectively arranged into the pixels; a drive unit that controls a light-emitting state of the light emitting elements of each pixel so as to display a character or figure along with a background in the display unit by changing a color of each pixel; a memory unit that stores plural patterns of colors for characters or figures and colors for backgrounds; and a control unit that changes the color of the character or figure and the color of the background in the image displayed in the display unit by switching one of the patterns to another when the image that includes the characters or figure is displayed in the display unit.

### BACKGROUND OF THE INVENTION

1. Field of the Invention

The present invention relates to a display apparatus and a display control method that prevent uneven deterioration of a display.

Priority is claimed on Japanese Patent Application No. 2005-219599, filed Jul. 28, 2005, the content of which is incorporated herein by reference.

2. Description of Related Art

Organic electroluminescence (EL) displays have come to be used in recent display apparatuses that are provided in terminals such as mobile telephones and the like. An organic EL display enables a high luminance to be obtained at a low power, and is superior in terms of visibility, response speed, service life, and power consumption. In addition, because colorizing is easy, the use of organic EL displays in mobile terminals is increasing.

However, in the terminal of a mobile telephone, the images of marks that show the remaining battery charge and the radio wave reception condition are continuously displayed. When the same image is displayed at the same display position, there is a problem in that the luminance of this portion alone gradually deteriorates, and this causes an uneven deterioration of the display apparatus.

In order to solve such a problem, a display apparatus is known in which the display of a mobile terminal apparatus or a display apparatus is inverted. Such apparatuses can carry out processing in which all bits of the display data for each display pixel are inverted and processing in which the luminance is changed when there is no input for a predetermined time interval or greater (refer, for example, to Japanese Unexamined Patent Application, First Publication No. 2002-268601, and Japanese Unexamined Patent Application, First Publication No. 2003-186434). In addition, a terminal apparatus is known in which the display screen is divided into a plurality of areas, and one of the divided areas is selected depending on time data so that the display area of the images of marks is changed (refer, for example, to Japanese Unexamined Patent Application, First Publication No. 2003-223160).

However, in the display apparatuses disclosed in JP 2002-268601A and JP 2003-186434A, because the displayed image is displayed after being inverted, there is a problem in that a user may experience a discomfort when viewing the display after significant changes. In addition, in the display apparatus disclosed in JP 2003-223160A, a user may become difficult to view the display of the images because the display position changes.

### SUMMARY OF THE INVENTION

In consideration of the problems described above, it is an object of the present invention to provide a display apparatus and a display control method that enable preventing the uneven deterioration of a display used in a mobile terminal or the like without causing discomfort to the user.

The present invention provides a display apparatus having a display unit that displays images formed by pixels arranged in a plurality of rows and columns, including: light emitting elements that are respectively arranged into pixels; a drive unit that controls a light-emitting state of the light emitting elements of each pixel so as to display a character or figure (marks) along with a background in the display unit by changing a color of each pixel; a memory unit that stores plural patterns of colors for characters or figures and colors for backgrounds; and a control unit that changes the color of the character or figure and the color of the background in the image displayed in the display unit by switching one of the patterns to another when the image that includes the characters or figure is displayed in the display unit.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram showing the configuration of an embodiment of the present invention;

FIG. 2 is a flowchart showing the operation of the apparatus shown in FIG. 1;

FIG. 3 is an explanatory drawing showing the table structure of the color scheme table stored in the display image memory unit 8 shown in FIG. 1; and

FIG. 4 is an explanatory drawing showing the table structure of the pattern data table stored in the display image memory unit 8 shown in FIG. 1.

### DETAILED DESCRIPTION OF THE INVENTION

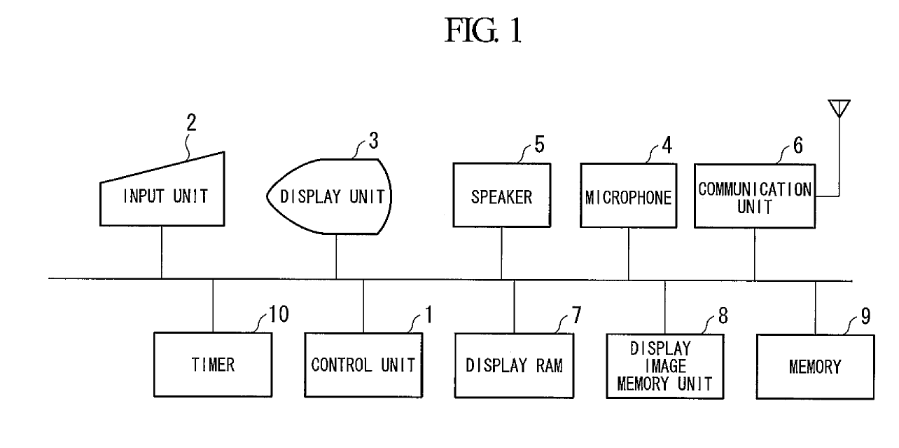

Below, a display apparatus according to an embodiment of the present invention will be explained with reference to the figures Here, a display apparatus that is provided on a mobile terminal such as a mobile telephone or the like is explained as an example. FIG. 1 is a block drawing showing the configuration of this embodiment. In this figure, reference numeral 1 denotes a control unit that carries out overall control of the processing actions of the mobile terminal. Reference numeral 2 denotes an input unit that serves as an operating unit, and includes a dial key, a function key, or the like. Reference numeral 3 denotes a display unit that displays a remaining battery charge mark, a radio wave reception condition mark, and arbitrary images or the like, that is formed by an organic EL display, and that is capable of displaying color images. Reference numeral 4 denotes a microphone that picks up the sound of a caller's voice. Reference numeral 5 denotes a speaker that emits the voice of a person on the other end. Reference numeral 6 denotes a communication unit that establishes wireless communication with a base station apparatus (not illustrated) and realizes a telephone function and data communication. Reference numeral 7 denotes display RAM (Random-Access Memory) for displaying images and the like in the display unit 3. Reference numeral 8 denotes a display image memory unit that stores data for displayed images in order to display some predetermined images (images concerning a remaining battery charge, a radio wave reception condition, a clock, a function selection screen, and the like) in the display unit 3. Reference numeral 9 denotes a memory that stores applications that are executed on a mobile terminal and data that is downloaded via the communication unit 6. Reference numeral 10 denotes a timer that measures a fixed time interval.

First, the display unit 3 shown in FIG. 1 will be explained. Here, an organic EL display will be explained as an example. The display unit 3 is structured so as to be capable of displaying images composed of pixels arrayed in a plurality of columns and rows. In addition, in the display unit 3, a plurality of light emitting electrodes in each pixel, here, red, blue, and green (that is, RBG) light emitting elements, are arranged, each pixel is individually illuminated by these three light emitting elements, and an image is displayed by consecutively illuminating the plurality of pixels. Note that because each pixel is formed by a combination of the three red, blue, and green lighting elements, by changing the pattern of the luminous intensity of each of these light emitting elements, the overall emitted color of the pixel is produced. Depending on the laws of the three primary colors of light, it is possible to produce yellow, purple, and the like, or produce white by strongly illuminating all three light emitting elements or produce black, which is the color of the ground of the display, by turning off the illumination of all of the light emitting elements. In this manner, for each pixel, it is possible to assign the emitted color of the pixel by a combination (pattern) of signals that assign the luminous intensity of each of the three light emitting elements. In addition, by assigning a pattern for a pixel with respect to the plurality of pixels, it is possible to change the color display of each pixel of the display unit 3, and it is possible thereby to display the display items such as pictures, animations, illustrations, marks, characters, signs, and icons, and the background color thereof. In addition, because these light emitting elements are self-illuminating, there is no need for a separate backlight.

However, a light emitting element has a service life. Although the service life has been somewhat extended due to technological progress, it is about 1000 hours. When the same display item continues to be shown at the same location, the same light emitting elements of the same pixel are continuously overused, and there is a high possibility that the service life of the most used light emitting elements will come to an end quickly.

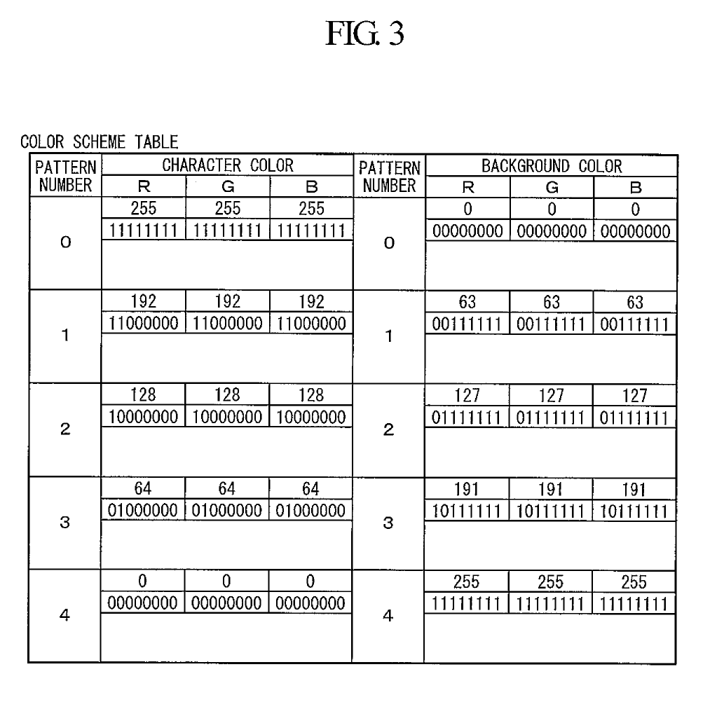

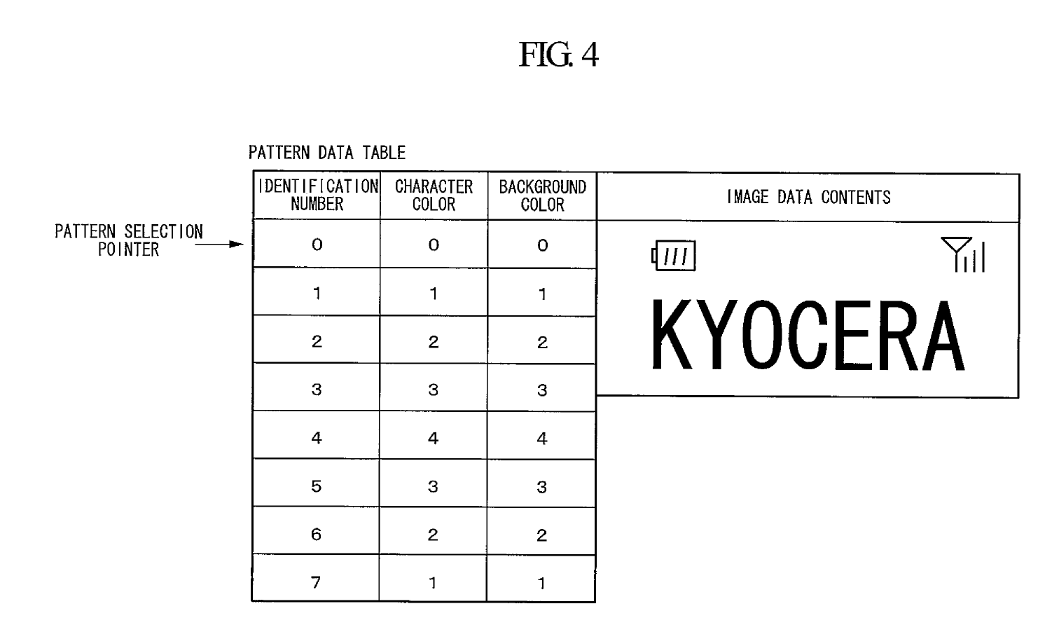

Next, referring to FIG. 3 and FIG. 4, the table that is stored in the display image memory unit 8 shown in FIG. 1 will be explained. First, FIG. 3 shows the structure of a color scheme table stored in the display image memory unit 8 shown in FIG. 1. The “character color” denotes the color scheme patterns of the colors used when characters, symbols, or figures and the like are displayed. The “background color” denotes the color scheme pattern of the colors used in the background portion outside the characters, symbols, and figure portions that are the object of the display in a predetermined display area. The color scheme pattern of the character color is defined such that the respective RGB values vary from 255 to 0 (i.e., change such that all the bits are inverted when the respective RGB values are represented using 8 bits). In addition, the color scheme pattern of the background color is defined such that the respective RGB values change from 0 to 255 (i.e., change such that all the bits are inverted when the respective RGB values are represented using 8 bits). FIG. 3 shows an example in which five color scheme patterns for the various character colors and background colors are stored in association with pattern numbers. However, the number of the color scheme patterns is not to five, and depending on necessity, an arbitrary number of the color scheme patterns may be stored.

Next, FIG. 4 is a drawing showing the structure of the pattern data table that is stored in the display image memory unit 8 shown in FIG. 1. The pattern data table is a table in which the contents of the image data that is to be displayed and the combination of various color scheme pattern numbers for character colors and background colors are stored in association with an identification number 0 through 7. Image data is data that can identify whether any pixel in a predetermined display area is a character (figure) or background, and is a set of pixel data in which “1” identifies a character (figure) portion and “0” identifies a background portion. FIG. 4 shows an example in which a remaining battery charge mark, a radio wave reception condition mark, and a company logo are stored as image data. For example, when the characters for “KYOCERA” are acquired as a displayed image on the Internet via the communication unit 6, the following display control is carried out. The control unit 1 sets the acquired characters for “KYOCERA” to an object “1” that is to be displayed, and at the same time, specifies the coordinates where the characters are to be displayed according to display coordinates defined on an Internet web page, and writes the characters into the display RAM 7. In addition, the control unit 1 acquires the “reception condition mark” and the “remaining battery charge mark” in a manner to be described below, and writes the “reception condition mark” and the “remaining battery charge mark” into the display RAM 7 as a display object “1” for display coordinates that are specified in advance. While these are displayed, when the display object is displayed in the display unit 3, in the coordinates for the background, a “0” is written into the display RAM 7 to assign a background portion. In addition, the color scheme patterns to be used are defined such that, among the color scheme patterns stored in the color scheme table, color scheme patterns having a small difference in color are stored adjacent to each other. Specifically, the pattern numbers 0 to 4 for both the character color and the background color are allocated to the identification numbers 0 to 4, the pattern numbers 3, 2, and 1 for both the character color and background color are allocated to the identification numbers 5, 6, and 7, and thus color scheme patterns whose pattern number values differ by “1” are adjacent to each other. In addition, in the case of the identification numbers “0” and “7”, the color scheme patterns whose pattern number values differ by “1” are adjacent to each other color, as well.

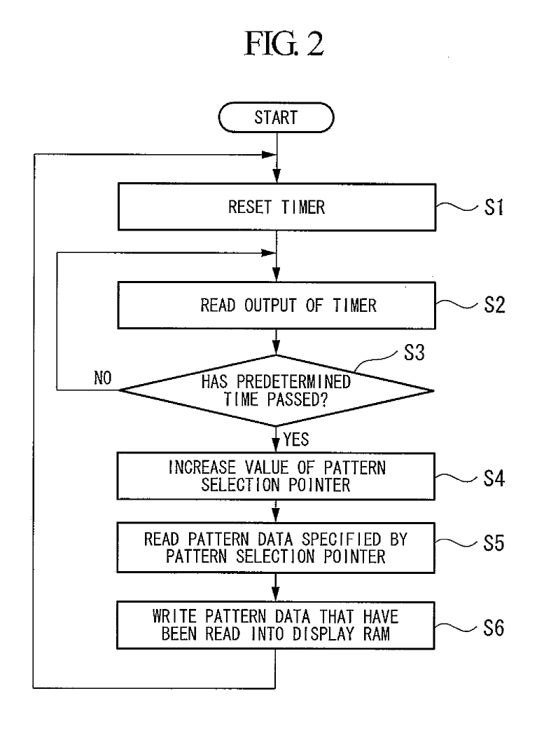

Next, the operation of the mobile terminal shown in FIG. 1 will be explained with reference to FIG. 2. First, when the electric power of the mobile terminal is turned on, the control unit 1 outputs a reset signal to the timer 10. Upon receiving the reset signal, the timer 10 resets the value of the measured time. Then the timer 10 outputs a timer interrupt signal to the control unit 1 at the point in time that a predetermined time interval (for example, 3 minutes) has passed (steps S2 and S3). Upon receiving the timer interrupt signal, the control unit 1 reads the value of the pattern selection pointer from the memory 9 (when a predetermined time interval has passed), increases the value of this pattern selection pointer (i.e., “1” is added), and again writes the increased value into the memory 9 (step S4). The pattern selection pointer is a pointer having values from 0 to 7, and the value thereof returns to “0” when an increment is executed at the value of “7”.

Next, the control unit 1 reads the pattern data having an identification number with the same value as the pattern selection pointer after being increased from the pattern data table in the display image memory unit 8 (step S5). For example, if the pattern selection pointer is “1”, then the character color pattern number “1”, the background color pattern number “1”, and the image data contents are read. Then, from the color scheme table stored in the display image memory unit 8, the control unit 1 reads the color scheme data (RGB values) corresponding to the character color pattern number and the background color pattern number that are included in the pattern data that has been read. For example, if the character color pattern number is “1”, then (R, G, B)=(192, 192, 192), and if the background color pattern number is “1”, then (R, G, B)=(63, 63, 63). Here, the pattern data and the color scheme data that have been read are stored in the control unit 1.

Next, the control unit 1 finds the remaining battery charge from the voltage of the battery (not illustrated), and determines which remaining battery charge mark should be displayed. In addition, the control unit 1 detects the radio wave reception condition in the communication unit 6, and determines which radio wave reception condition mark should be displayed. Then the control unit 1 generates the data for the images that should be displayed in the display unit 3 based the image data that has been read, and the remaining battery charge mark and the radio wave reception condition mark that have been determined and writes the image data into the display RAM 7 as the display objects for the coordinates that have been specified in advance so that these images are displayed at predetermined positions (step S6). At this time, the control unit 1 assigns the RGB values of the characters and background in the image to be displayed based on the color scheme data that has been read. Thereby, in the display unit 3, the images (the remaining battery charge mark, the radio wave reception condition mark, and the company logo) shown in FIG. 4 are displayed by using the color scheme data specified by the pattern selection pointer.

Next, the control unit 1 carries out the reset (step S1) again, and repeatedly executes the processing of steps S2 to S6 until the power is turned off. Thereby, the display of the images is carried out while the color scheme pattern is switched after the passage of a time interval. However, in the case in which the remaining battery charge condition or the radio wave reception condition changes before a new pattern data is read (before a predetermined time interval has passed), the updating of the remaining battery charge mark and the radio wave reception condition mark is carried out by using the pattern data and the color scheme data stored internally.

In this manner, when a predetermined image is displayed at the same position in the display unit 3, because the color scheme pattern of the image is changed when a predetermined time interval has passed and the luminance of each pixel is changed at a predetermined time interval, it is possible to prevent a specific pixel from deteriorating, and by extending thereby the service life of each pixel in comparison to continuously displaying an identical image at an identical position on a display unit 3, it is possible to prevent the deterioration of a particular portion on the display apparatus. In addition, when the color scheme pattern is switched from one to another, the switching is arranged so that the change in the color scheme is small. Therefore, it is possible to change the color scheme pattern of the displayed image without causing discomfort to the user, and thereby the effect is obtained in which it is possible to prevent uneven deterioration of displays used on mobile terminals or the like without causing discomfort to the user. In addition, in the case in which the pattern selection pointer for selecting the pattern data is stored in non-volatile memory and the power of the mobile terminal is restored after having been turned off, because pattern selection is carried out based on a pattern selection pointer that has been stored, it is possible to make the utilization frequency of each of the data patterns equal. Thereby, it is possible to solve the problem in which the utilization frequencies of each pattern data become unequal when the pattern data to be used each time the power is turned on is determined in advance (for example, the pattern data having the identification number “0”), which results in the utilization frequency of the predetermined pattern data becoming high. In addition, when the operation of the input unit 2 starts while the image is displayed in the display unit 3 by using the pattern of identification number 4, it is possible to prevent the color of the remaining battery charge mark from suddenly changing from character color pattern 4 to pattern 0, which causes the appearance of the display colors to change significantly, and by carrying out control so that the pattern does not fluctuate significantly when an operation of the input unit 2 occurs, it is possible to limit the amount of change in the appearance.

Note that, in addition to the passage of a predetermined time interval, switching the pattern data to be used may also be carried out at the point in time that a predetermined operation is carried out. For example, in the cases such as using an application to display images such as photographs pictures) and videos (animations) that have been downloaded on the entire screen of the display unit 3, the display of the remaining battery charge mark and the radio wave reception condition mark is temporarily suspended, and after the application has ended, the display of the remaining battery charge mark and the radio wave reception condition mark is resumed. When the display of the marks is resumed, it is possible to change the pattern data of the displayed images without causing discomfort to the user.

In addition, when the input unit 2 is operated and a request for a function selection is made, the control unit 1 may display a function selection screen that includes at least a predetermined character string in the display unit 3 and may carry out the pattern control processing while displaying this function selection screen. In addition, when a request for communication is made by the communication unit 6 after the input unit 2 has been operated, the control unit 1 may display a communication related screen that includes at least a predetermined character string in the display unit 3 and may carry out the pattern control processing while displaying this communication related screen. For example, when a call request is made, a screen for inputting a telephone number is displayed, and when a content E-mail is made, a screen for receiving character input from the input unit 2 is displayed. Such a communication related screen and function menu screen for setting the function are handled as display objects in the display RAM 7, and the display coordinates thereof are basically fixed. Consequently, by carrying out the pattern control processing disclosed in the present invention, even in a communication related screen or a function menu screen, it is possible to prevent a portion of the light emitting elements among a portion of the pixels in the display unit 3 from being overused. In addition, pattern switching control processing is not carried out in the case in which an image is displayed in which the colors of each of the pixels of the image that is to be displayed are meaning-laden, such as when displaying an image such as a photograph (picture), a video (animation), or an illustration.

Note that the mobile terminal of the present invention may include, for example, a mobile telephone that uses mobile communication, a mobile information terminal (PDA) that has a mobile communication function, a mobile terminal, or a car navigation apparatus and the like.

Note also that an example of pattern control has been explained in which the signal values for the respective RGB colors are the same values and they are all switched in sequence together. However, this is simply one example, and each of the RGB signal values may be changed independently.

Note that programs for realizing the functions of the processing units in FIG. 1 may be recorded on computer-readable recording media, and image display control processing may be carried out by reading and executing the programs recorded on this recording media by a computer system. Note also that here “computer system” includes an OS and hardware such as peripheral devices. In addition, “computer-readable recording media” denotes portable media such as flexible disks, magneto-optical disks, ROMs, CD-ROMs and the like, and memory apparatuses such as the hard disks or the like that are built into a computer system. Furthermore, “computer-readable recording medium” also includes volatile memory (RAM) in a computer system consisting of servers and clients when a program is transmitted via a network such as the Internet or communication lines such as telephone circuits that temporarily store the program.

In addition, the program described above may be transmitted from a computer that stores this program in a memory apparatus or the like to another computer system by a transmission medium or by transmitted waves propagating through a transmission medium. Here, a “transmission medium” that transmits a program denotes a medium having the function of transmitting information, including networks (communication networks) such as the Internet or communication circuits (communication lines) such as a telephone circuit. In addition, the program described above may realize a portion of the functions described above. Furthermore, what is called a distributed file (distributed program) that realizes the functions described above in combination with programs already stored on a computer system may be used.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A display apparatus having a display unit that displays images formed by pixels arranged in a plurality of rows and columns, comprising:
light emitting elements that are respectively arranged into the pixels;
a drive unit that controls a light-emitting state of the light emitting elements of each pixel so as to display a character or figure along with a background in the display unit by changing a color of each pixel;
a memory unit that stores plural patterns of colors for characters or figures and colors for backgrounds; and
a control unit that changes the color of the character or figure and the color of the background in the image displayed in the display unit by switching one of the patterns to another when the image that includes the characters or figure is displayed in the display unit.

2. The display unit according to claim 1, wherein the control unit switches one of the patterns to another at a predetermined time interval.

3. The display unit according to claim 1, wherein the control unit switches one of the patterns to another when an image that includes a predetermined character string is displayed in the display unit by the drive unit.

4. The display apparatus according to claim 3, further comprising: an operating unit, wherein
the drive unit operates the display unit to display a function selection screen that includes a predetermined character string when a function selection is requested by the operating unit, and
the control unit switches one of the patterns to another when the function selection screen is displayed due to an operation of the drive unit.

5. The display apparatus according to claim 1, further comprising a communication unit that enables connection to a communication network, wherein
the drive unit operates the display unit to display a communication related screen that includes a predetermined character string when communication is requested by the communication unit, and
the control unit switches one of the patterns to another when the communication related screen is displayed due to an operation of the drive unit.

6. The display apparatus according to claim 5, wherein the communication related screen is a screen in which messages that have been sent or received by the communication unit are displayed or a screen that is displayed when a call request is made by the communication unit.

7. The display apparatus according to claim 1, wherein the control unit does not switch one of the patterns to another when the image displayed due to an operation of the drive unit is an image in which a color of each of the pixels of the image is meaning-laden.

8. The display apparatus according to claim 1, wherein the control unit does not switch one of the patterns to another when the image displayed due to an operation of the drive unit is either a picture, an animation, or an illustration.

9. The display apparatus according to claim 1, wherein the control unit switches one of the patterns to another in accordance with a predetermined switching sequence.

10. The display apparatus according to claim 9, wherein, when the control unit carries again out image displays accompanied by pattern switching after the image displays accompanied by pattern switching is completed, the control unit begins the image displays based on one of the patterns used at completion of the previous image displays, or on next one of the patterns in accordance with the predetermined switching sequence.

11. The display apparatus according to claim 9, wherein the predetermined switching sequence is set such that changes in colors are comparatively small among the plural patterns.

12. The display apparatus according to claim 1, further comprising:
a battery that supplies electric power; and
a remaining battery charge measuring device that measures a remaining battery charge of the battery, wherein
the drive unit operates the display unit to display icon that indicates the remaining battery charge that has been measured by the remaining battery charge measuring device, and
the control unit executes switching of the patterns on at least an area in which an icon that indicates the remaining battery charge is displayed.

13. The display apparatus according to claim 1, wherein
the drive unit operates the display unit to display time or date information, and
the control unit executes switching of the patterns on at least an area in which the time or date information is displayed.

14. The display apparatus according to claim 1, further comprising a communication unit that enables communication with a communication network, wherein
the control unit operates the display unit to display an icon that indicates a state of the communication with the communication network by the communication unit, and
the control unit executes switching of the patterns on at least an area in which the icon is displayed.

15. A display control method in a display apparatus having a display unit that displays images formed by pixels arranged in a plurality of rows and columns, the display control method comprising:
controlling a light-emitting state of light emitting elements that are respectively arranged into pixels so as to display a character or figure along with a background in the display unit by changing a color of each pixel;
storing plural patterns of colors of characters or figures and colors of backgrounds; and
changing the color of the character or figure and the color of the background in the image displayed in the display unit by switching one of the patterns to another when the image that includes the characters or figure is displayed in the display unit.

16. The display control method according to claim 15, wherein the switching in the patterns is carried out at a predetermined time interval.
